(19) United States
(12) Patent Application Publication
(10) Pub. No.: US 2007/0189267 A1
(43) Pub. Date: Aug. 16, 2007

(54) Voice Assisted Click-to-Talk

(75) Inventors: Michael D. Metcalf, Ladera Ranch, CA (US); Tracy Roberts, Mountain View, CA (US)

Correspondence Address: DAVID L. THOMSON, 4480 BASSWOOD DR., LISLE, IL, 60532, US

(73) Assignee: MDM INTELLECTUAL PROPERTY LLC, Rancho Santa Margarita, CA (US)

(21) Appl. No.: 11/307,680

(22) Filed: Feb. 16, 2006

(51) Int. Cl. H04L 12/66

(52) U.S. Cl. 370/352

(57) ABSTRACT

A link is associated with an icon attached to an email message or web site. When a person activates the link, a voice path is opened to a voice assistant. The voice assistant sets up a voice call between the client and a telephone number.

### FIELD OF THE INVENTION

The present invention relates to telecommunications systems and methods and, more particularly, to a method for allowing a computer icon and a voice assistant to set up a telephone call.

### BACKGROUND OF THE INVENTION

This invention addresses the problem of setting up a telephone call from email reader or a web site browser. An email recipient may reply to the email sender by typing a return email message, but there are times when a telephone conversation would be preferred, in which case the recipient must have access to the sender's telephone number, either from the email, a directory listing, or from the recipient's contact list. In addition, it is necessary for the recipient to dial the telephone number. Likewise, a visitor to a web site may wish to talk to a web site representative such as a sales agent or webmaster, in which case the visitor must find the telephone number on the web site or by some other means and then dial the number.

In this document we refer to the person who initiates the call, such as the email recipient or web site visitor, as the “client.” We refer to the person or machine receiving the call, such as the email sender or the web site representative, as the “host.”

Click-to-Talk systems exist that allow an icon to be attached to email or displayed on a web page that sets up a voice call between a client and a host. This system typically includes a software module that runs on the client's computer and a VoIP (Voice over Internet Protocol) gateway that converts voice packets to and from the client's computer to telephone signals that are sent to and from the host's telephone. When the client selects an icon on a computer screen by clicking on it with a mouse, whether the icon is attached to an email message or a web page, the icon sets up a voice call to the host at a telephone number associated with the icon so that the client can talk to the host. The action of placing the call uses software already on the client's computer or downloaded to the client's computer from a server in the network. Setting up the voice call may also require other network elements, such as a softswitch, session controller, SIP proxy, or VoIP gateway, using standard methods known in the art. Since the voice path goes through the computer, click-to-talk is only possible if the client's computer has a microphone and speaker or an audio headset.

While click-to-talk is a convenient way for the client to call the host, it is only partly useful if the host has several telephone numbers, since the host may not be available at the particular telephone number associated with the icon. In addition, the host may not wish to be disturbed when the client calls. Another shortfall of click-to-talk is it that cannot execute a transaction more complex than simply placing a telephone call. For example, the telephone number may be the main number for a business and the client may need to talk to a particular person at that business. The host telephone number may connect a machine that requires the client to provide more information before completing a call or desired transaction. The host telephone number may be to a transaction server at a bank that requires the client to input account numbers or other information. Network games, stock services, and information portals such as news reports often require input from the caller. Some of these limitations may be overcome by providing a means for the client to use a software dialpad that generates touch-tones, but a touch-tone interface may be cumbersome for many applications. What is needed is a method for providing additional click-to-talk options to overcome the limitations.

### SUMMARY OF THE INVENTION

In accordance with one aspect of the invention, the aforementioned problem has been solved and a technological advance achieved by using a voice assistant equipped with service logic, network interfaces, a speech recognizer, a set of recorded prompts, and a text-to-speech synthesizer so that it can handle the call or transaction with the client and host. The voice assistant has a list of telephone numbers for the host and can try them in order or all at once. The assistant may also ask the client for the name of the person the client wishes to speak to. The assistant may ask for the client's name and record the result, then play the recording to the host so the host can decide whether to take the call. The assistant may recognize voice commands and interact with a transaction server such as news service or stock trading system. When this description of the current invention refers to a “telephone number,” it is understood that a telephone number may take different forms, depending the technology employed, and that a telephone number may be understood to include a digit string, a SIP address, an email address, a user name or handle, or other identifier used to specify a telephone, VoIP phone, video phone, softphone, telephone-enabled PDA or other device, Wi-Fi phone, Wi-Max phone, peer-to-peer phone, instant messaging software or device, or other device capable of enabling voice communication.

### BRIEF DESCRIPTION OF THE DRAWINGS

FIG. 1 shows a sample architecture for connections to a click-to-talk voice assistant.

FIG. 2 shows a flowchart for finding a host with a sequence of numbers.

FIG. 3 shows a flowchart for finding a host with call blast.

FIG. 4 shows a flowchart for completing a call in response to spoken input from the client.

### DETAILED DESCRIPTION

In the following description, numerous details are set forth to provide an understanding of the present invention. However, it is to be understood by those skilled in the art that the present invention may be practiced without these details and that numerous variations or modifications from the described embodiments may be possible.

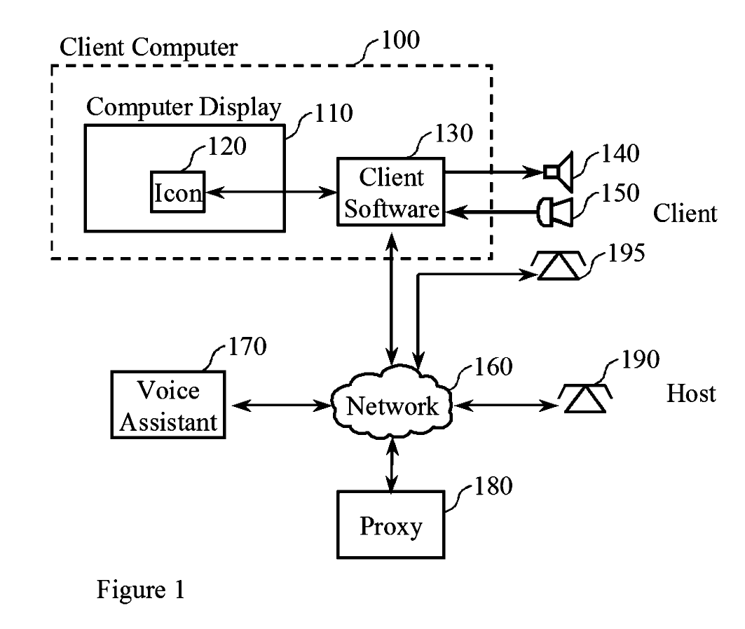

FIG. 1 illustrates an example architecture for a click-to-talk voice assistant. Client computer 100 is a desktop computer, a laptop computer, a PDA (Personal Digital Assistant), a cell phone, or other device capable of running software, receiving email, or browsing a web site. Computer display 110 is part of or attached to client computer 100. Icon 120 appears on display 110, advantageously as part of an email attachment, on a web page, or associated with software running on computer 100. In response to client selecting icon 120, client software 130 sets up a voice path through network 160 to voice assistant 170. We may refer to this client software, or portions of the client software, as a click-to-talk application or sometimes as simply a “client.” Other software and hardware modules may assist in setting up the voice path according to methods known in the art. In one embodiment of the invention, proxy 180 assists in address translation and other actions needed to set up the call. Proxy 180 is, for example, a session controller, SIP proxy, or peer-to-peer supernode.

In the preferred embodiment of the current invention, the client's voice path is via client computer 100 using speaker 140 and microphone 150. The client listens via speaker 140 and talks via microphone 150. In one embodiment of the invention, speaker 140 and microphone 150 are part of a telephone. In alternative embodiments, speaker 140 and microphone 150 constitute a headset, speakerphone, USB (Universal Serial Bus) audio device, or a microphone and speaker built into computer 100. In another alternative embodiment, client telephone 195 is used instead of speaker 140 and microphone 150. A first voice path is set up between client telephone 195 and voice assistant 170, and a second voice path is set up between client telephone 195 and host telephone 190. The first voice path is set up by a network entity such as voice assistant 170 placing a call to client telephone 195. When the client answers phone 195, a voice path is established. An alternative to voice assistant 170 placing a call to client telephone 195 is for the client to place a call by dialing a number provided by the email or website where icon 120 is attached.

Note that in a practical service, there may be multiple voice assistants or multiple hosts, so a means must be provided to connect a given client with the correct voice assistant and the correct host. In the preferred embodiment of the invention, the phone number of voice assistant 170 and the identity of the host and other host information are embedded in the definition of icon 120, i.e. the voice assistant phone number and host identity are sent together with icon 120 as part of an email attachment or are included as part of the code used to define icon 120 on a web site. The icon definition is a set of parameters that may include one or more URLs, IP addresses, telephone numbers, email addresses, HTML code or other software, user names or handles, host information, client information, or other data. In an alternate embodiment, an email address (for example the email address of the client or host), an IP address, or other identifier is embedded in the icon definition and mapped to a telephone number by referring to a database that associates icon identifiers with telephone numbers. In one illustrative example of the alternate embodiment, an email address belonging to the host is included in the HTML code that defines icon 120, so that when the client clicks icon 120, client software 130 searches a database and finds that the host email address is associated with a particular voice assistant 170 telephone number. The client software opens a voice path between the client and voice assistant 170 and sends the host email address to voice assistant 170. Voice assistant 170 uses the host email address to look up the host telephone number(s) in a database and then creates a voice path between the client and host telephone 190. In a second illustrative example, the voice assistant IP address or URL is embedded in icon 120. Client software opens a voice path between the client and voice assistant 170 at the embedded IP address or URL and transmits the IP address of client computer 100 to voice assistant 170. Voice assistant 170 checks a database and learns that the IP address of client computer 100 is associated with a particular host and is then able to set up a voice connection between the client and host.

In another alternate embodiment, the voice assistant or host telephone number is derived from cookies on client computer 100, the URL of the web site where icon 120 is found, the return email address or email address from which the email containing icon 120 is sent, the client computer's IP address, or information typed by the client.

Regardless of whether the voice assistant phone number is embedded in the icon or mapped from a database, there must be a means for populating the icon parameters or the database. The database is populated with mapping information by a service provider, by an automated configuration system, by the client, or by the host, where the host updates the database using a web site or a telephone interface. The host's telephone interface uses either speech recognition or touch-tone input to update the database.

It is to be understood that a phone number in the context of this invention may be a standard telephone number, an IP address or URL in a VoIP (Voice over Internet Protocol) system, a SIP address, a peer-to-peer handle, or any descriptor that specifies the network location of voice assistant 170, client telephone 195, or host telephone 190. Network 160 is network or combination of networks capable of carrying voice or data signals, such as a telephone network, a LAN or WAN, the Internet, a wireless network, a VoIP network, or a peer-to-peer network. Once the client is connected to voice assistant 170, voice assistant 170 determines what must be done to connect the client to host telephone 190. Only one telephone 190 is shown in FIG. 1, but the host may have several telephones.

In the preferred embodiment of the invention, the first voice path between the client and voice assistant 170 lasts only as long as necessary; once a second voice path between the client and the host is established, the first voice path is torn down. In an alternative embodiment, the first voice path is maintained in a conference call arrangement or a hairpinned configuration so that voice assistant 170 remains on the call. This conference/hairpin alternative is useful where voice assistant 170 may contribute to the communication between the client and host (such as converting voice commands to touch-tones) or when it is desired to allow the host or client to perform another action such as placing another call or executing another transaction once the other party hangs up.

FIG. 1 illustrates one embodiment where the voice assistant resides in the network. In an alternative embodiment, voice assistant 170 resides on client computer 100 or is downloaded after the client selects icon 120. In another alternative embodiment, voice assistant 170 is part of proxy 180 or part of the host. In the preferred embodiment, the host is a person; however in an alternative embodiment, the host is a machine such as an IVR system, a speech server, or an ACD (Automatic Call Distribution) switch. The database used to map icon identifiers to telephone numbers and other information may be part of or connected to client software 130, voice assistant 170, or proxy 180.

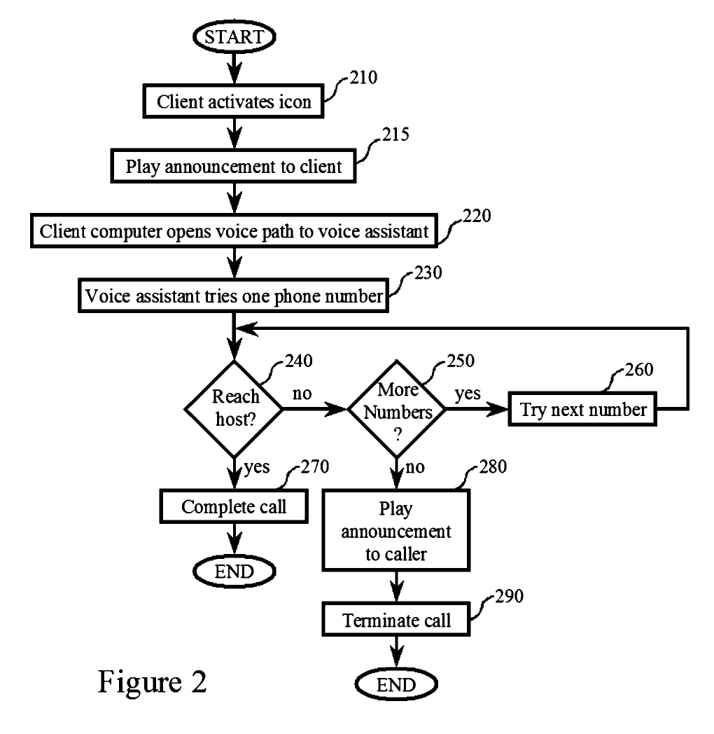

FIG. 2, a block diagram for a find-me service combined with click-to-talk, illustrates a case where the host has more than one telephone. In step 210, the client activates an icon, advantageously by clicking on the screen appearance with a mouse. In step 215, an announcement is played to the client. This announcement may be played by the client software 130 on the client's computer, by voice assistant 170, or by another entity in or attached to network 160. The announcement may be music on hold, an advertisement for the click-to-talk service, an advertisement for another product or service, or instructions for using the click-to-talk service. If the announcement is an advertisement, the announcement may also instruct the client how to subscribe to or purchase the product or service, which instruction may include clicking a button on the screen or calling a telephone number. If the client responds favorably, the client may then be asked to provide billing information such as a credit card number and/or name and address so that the product may be delivered or the service may be activated. This billing information may be collected by voice assistant 170, client software 130, a transaction server located at host 190, or by another entity residing in or attached to network 160. Note that step 215 is optional. In step 220 a voice path is opened to a voice assistant. The voice assistant tries a first host telephone number in step 230. If the host is reached and accepts the call, as determined in decision block 240, then the call is completed in step 270 and the client and host are able to communicate. If the voice assistant is unable to reach the host because the number is busy, the number is not available, the call goes to voicemail, there is no answer, the host refuses the call, or for any other reason, then a decision is made in decision block 250 to determine if the host has alternate numbers that have not yet been tried. In one embodiment of the current invention, if there are no untried numbers, a message is played to the client in step 280 and the call is terminated in step 290. In an alternative embodiment, steps 280 and 290 are replaced by a means for the client to leave voicemail. In other alternative embodiments, the client has an option of waiting on hold, trying to call a different number, or connecting to an IVR system. If the host has at least one number that has not yet been tried, then the next number is tried in step 260. Each number is tried until the host is reached or until there are no more numbers to try.

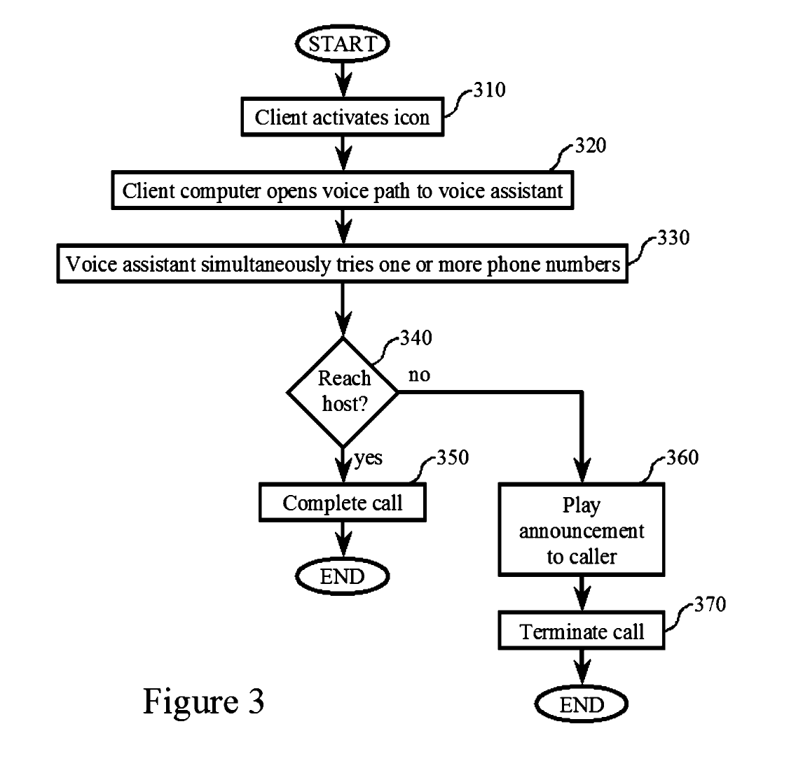

FIG. 3 illustrates an alternative embodiment where the voice assistant uses “call blast,” meaning that all host telephones ring at the same time. The client activates an icon in step 310. In step 320 the client is connected to a voice assistant. In step 330, the voice assistant places a call attempt to multiple phone numbers simultaneously. All host telephones ring until the host accepts the call or until the client hangs up or until a system timeout occurs. Decision block 340 determines if the host was successfully reached and, if the answer is yes, the call is completed in step 350. In one embodiment of the current invention, if the voice assistant is unable to reach the host because the number is busy, the number is not active, there is no answer, the host refuses the call, or for any other reason, then a message is played to the client in step 360 and the call is terminated in step 370. In an alternative embodiment, steps 360 and 370 are replaced by a means for the client to leave voicemail. In other alternative embodiments, the client has an option of waiting on hold, trying to call a different number, or connecting to an IVR system.

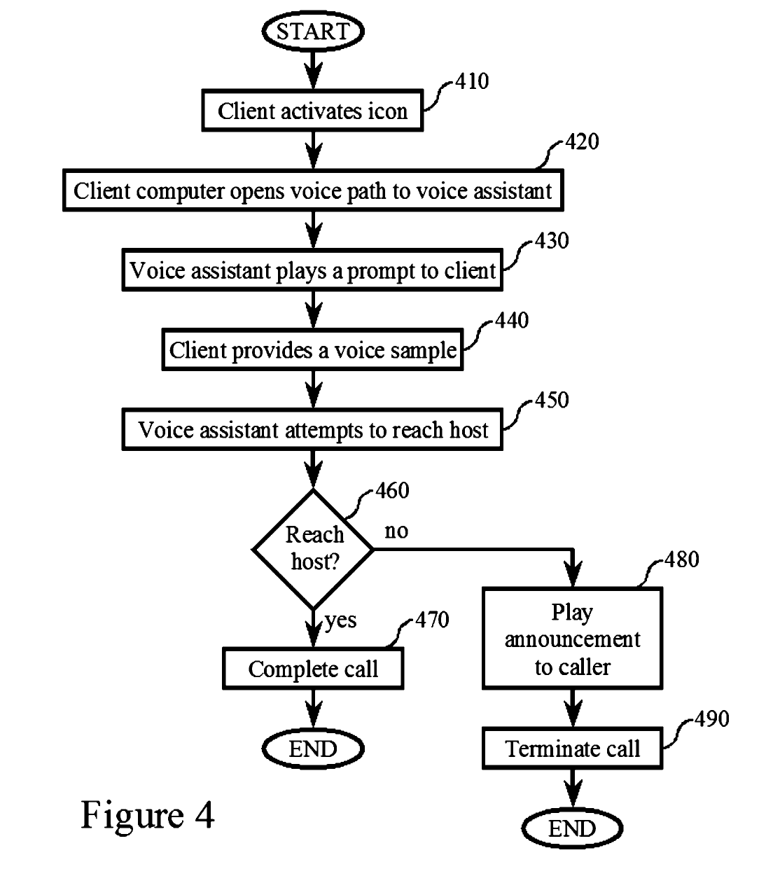

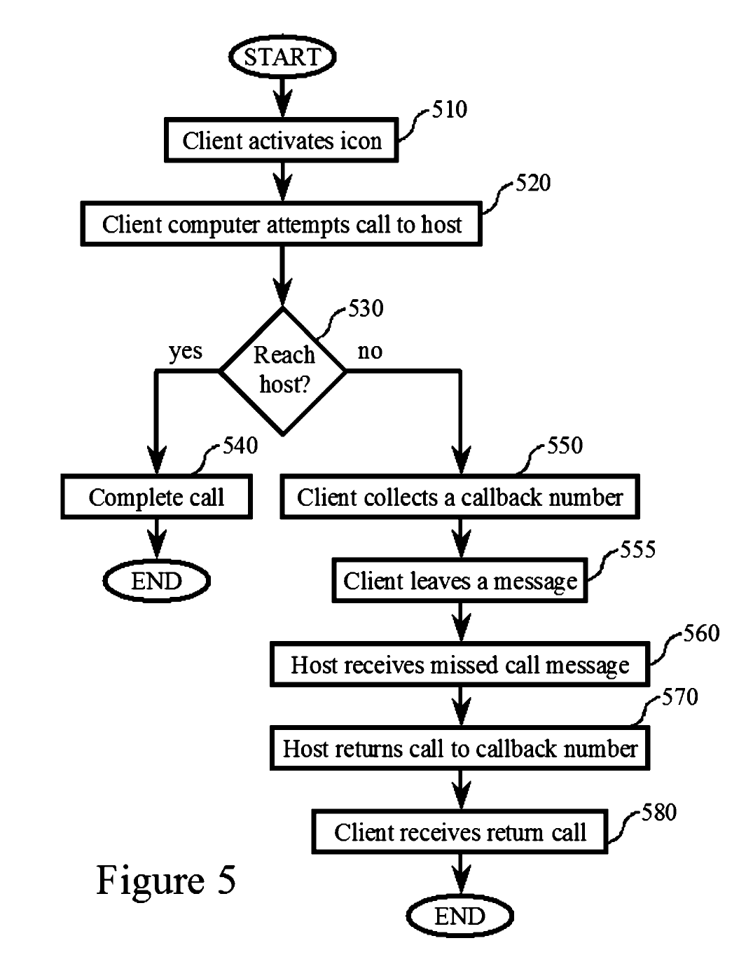

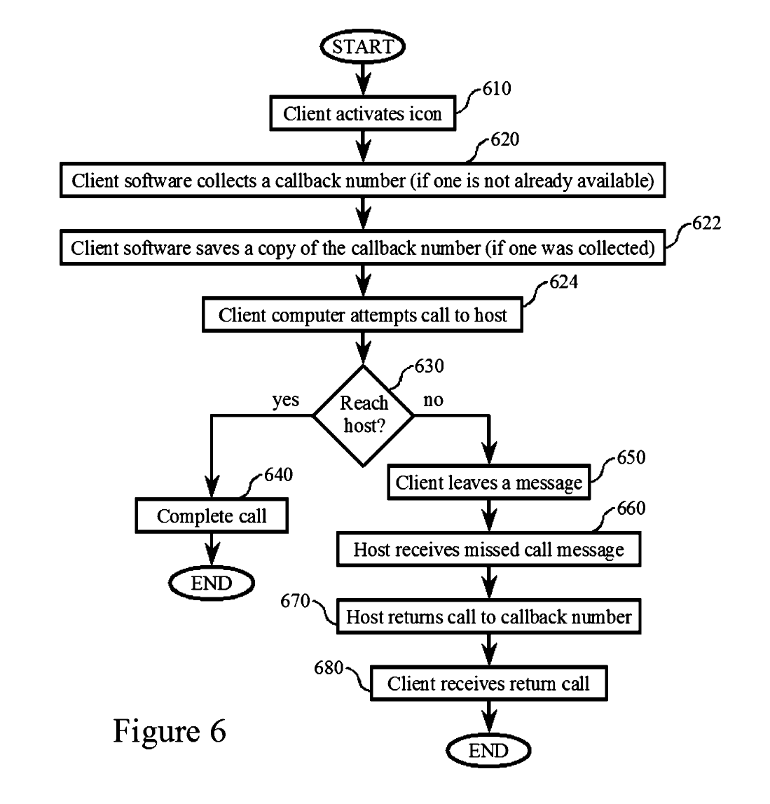

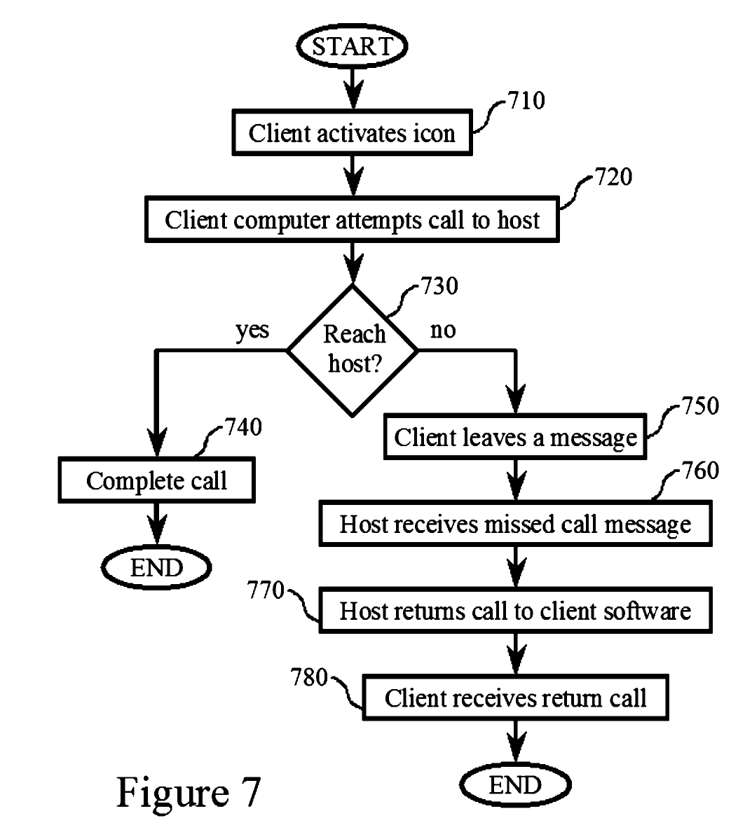

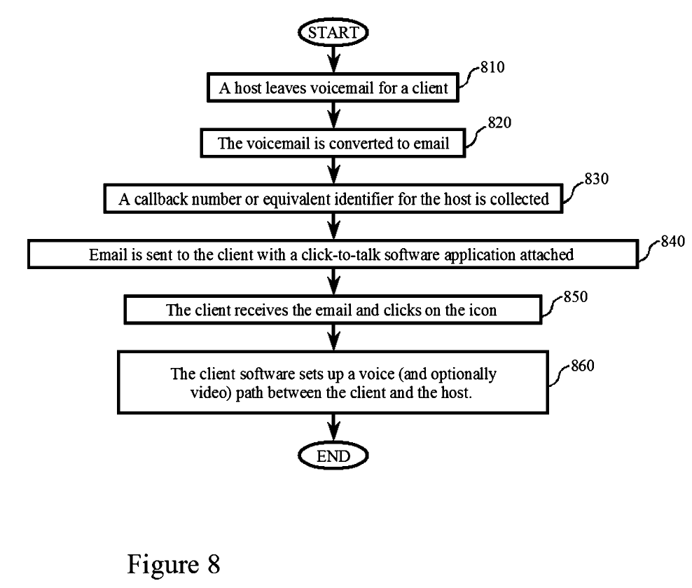

FIG. 4 illustrates a case where input from the client is accepted. The client activates an icon in step 410 and a voice path to a voice assistant is opened in step 420. In the preferred embodiment, the voice assistant plays a prompt to the client in 430. The prompt may be, for example, a tone or an announcement such as, “please say your name” or “would you like to talk to sales or customer service?” In an alternative embodiment, the client is prompted visually with text or images on a display, optionally in addition to the audio prompt. In step 440, the client provides a voice sample containing, for example, the client's name, the name of the person or department the client wishes to speak to, billing or account information, or a request for a particular service or action.

In one embodiment of the invention, the host is a single person with a single telephone number. In another embodiment of the invention, the host has several telephones or may be more than one person. The voice assistant may ask the client which telephone number to try or whom he/she wishes to speak to. A speech recognizer is used to recognize the client's voice sample. A database lookup converts the recognized voice sample to a telephone number corresponding to the recognized voice sample.

In response to the client's voice sample, an attempt is made to reach the host in step 450. If the host is determined to be reachable in block 460, the call is connected in step 470; otherwise, an announcement is played in step 480 and the call is terminated in step 490. In an alternative embodiment, steps 480 and 490 are replaced by a means for the client to leave voicemail. In other alternative embodiments, the client has an option of waiting on hold, trying to call a different number, or connecting to an IVR system.

In some cases, such as for privacy or because one or more of the host telephone numbers has voicemail, it is useful to ask the host to accept or reject the call. In one embodiment of the current invention, decision blocks 240, 340, or 460 judge the host to have been reached if any one of the host telephones are answered. In an alternative embodiment, additional security is provided by asking for the client's name and playing a recording of the client saying his/her name to the host so that the host can decide whether to accept. In other alternative embodiments, information regarding the client's identity is derived from from the client's caller ID, the client's name extracted from information on the client computer or from a caller ID reverse directory lookup, the client's email address, or other client identification information is provided to the host via an audio prompt or a visual display so that the host can decide whether to accept or reject the call.

In one embodiment of the current invention, the host may accept or reject the call by pressing a touch-tone button. In an alternative embodiment, the host may accept or reject the call by speaking a key word in response to a prompt. In another alternative embodiment, the host may click a region on a touch screen or a press a button. Note that if one of the host numbers tried by the voice assistant goes to voicemail and if the voice assistant is listening for a particular key word or touch-tone as a signal that the host has accepted the call, the voicemail system will advantageously not accept the call, and the voice assistant will try the next host telephone number. The system may alternatively be configured to allow one of the host numbers to accept voicemail from the client or a separate voicemail system may be set up to take voicemail from the client if the host is unreachable. Once the host is reached and the host accepts the call, the “yes” path is taken from the “Reach host?” decision block. If the host is not reached or does not accept the call, the “no” path is taken.

In one embodiment of the current invention, announcement blocks 280, 360, or 480 are audio prompts. In an alternative embodiment, blocks 280, 360, or 480 are replaced with visual feedback to inform the client of the call attempt status using a display such as a screen on a computer or handheld device.

In the embodiment of the current invention shown in FIG. 4, the call terminates if the host is unreachable, the call ends. In a second embodiment, if the host is unreachable, the voice assistant takes a voice message or a text message typed by the client. The host can later retrieve said message. In a third embodiment, in addition to taking a message, the voice assistant collects a callback number (or a SIP address, IP address, email address, or other identifier that functions as a callback number) so that the host can easily return a call to the client. FIGS. 5, 6, and 7 illustrate three examples of how the callback number may be collected by the voice assistant (sometimes with assistance of the client software).

FIG. 5 illustrates a first example of how the client may leave a callback number for the host. The client activates the icon in block 510 and the client software attempts to reach the host in block 520. Block 530 determines if the host is reachable. If the host is reachable, the call is completed in block 540. If the host is not reachable, the client software collects a callback number in block 550. In one embodiment of the current invention, the callback number is collected by a window on the computer screen asking for a number and the client is expected to type a number on the computer keyboard. This number corresponds to a cell phone number, a work phone number, a SIP address, and email address, or other number that the client's preferred device—the one he/she wishes to use to receive the return call. In an alternative embodiment, the client provides the number by (1) speaking the number, (2) selecting from one of several numbers displayed on the computer screen, or (3) speaking the name of a location. The collected callback number is forwarded to a message service (optionally part of the voice assistant), where it is available for the host. The client, either through deliberate action or automatically as part of the click-to-talk service, leaves a message in block 555 informing the host that the client called, optionally including a voice message. When the host later retrieves voicemail, email, or otherwise accesses the voice assistant or message service in block 560, he/she receives the message left in step 555 and thus learns that the client has called. In block 570, the host calls the client back at the number collected in step 550. Since the callback number is stored electronically by the voice assistant, the host need not dial the number and may return the call simply by speaking a voice command (such as “callback”), pressing a DTMF command, clicking an icon on a screen, pressing one or more buttons on a communication device such as a Wi-Fi phone, cell phone, videophone, or PDA or otherwise activating a callback function. When the host returns the call, the client's preferred device receives the call in block 580 and the client and host are able to communicate.

FIG. 6 shows a second example where the callback number is collected by the client software before the call is placed or during the call attempt. (We say “before” or “during” because blocks 620 and 624 may happen in sequence or simultaneously.) The client activates the icon in block 610. The client software collects a callback number in block 620. (If a callback number was previously collected, block 620 may be skipped.) For examples of how the callback number may be collected, see the description of block 550. If a callback number was collected in block 620, the client software optionally saves a copy of the callback number in block 622 so that the callback number need not be collected again if the host calls again. The client software attempts to reach the host in block 624. Block 630 determines if the host is reachable. If the host is reachable, the call is completed in block 640. If the host is not reachable, the client leaves a message in block 650. When the host later receives the message in block 660, he/she learns that the client has called. In block 670, the host calls the client back at the number collected in step 620 (or at the saved number, if there is one) and the client receives the return call in block 680.

Note that the strategy of storing a callback number so that it need not be collected next time applies also to FIG. 5, not just FIG. 6. This strategy is not shown in FIG. 5, but it may be implemented as follows: In block 550, a decision is made to determine if the callback number is already available, which it would be if the same host previously left a message for the same client, for example. If the callback number is available, then the step of collecting a callback number is skipped. If the callback number is not available, then it is collected in step 550 and stored for next time.

FIG. 7 shows a third example where, rather than connecting to a telephone specified by the client, the host calls the client software. The client software, in this example, is configured as a softphone that is able to take incoming calls. Since the client software and/or the voice assistant is/are able to determine the contact information for the client software, it is not necessary for the client to manually input a callback number. The client activates the icon in block 710. The client software attempts to reach the host in block 720. Block 730 determines if the host is reachable. If the host is reachable, the call is completed in block 740. If the host is not reachable, the client (and this may be either deliberately or automatically) leaves a message in block 750. When the host receives the message in block 760, he/she learns that the client has called. In block 770, the host calls the client back, a step consisting of opening a connection between the host and the client software. The client receives the return call in block 780.

In one embodiment of the invention, the icon is sent as an attachment to an email sent by the host. In this embodiment, we expect that the host has probably subscribed to a service that allows him/her to attach click-to-talk icons to outgoing email. In an alternative embodiment of the invention, the host, instead of sending email to the client, leaves voicemail for the client. (We might presume that the host is leaving voicemail for the client because the host attempted to call the client and was unsuccessful in reaching the client, thought he specific reason for the voicemail is unimportant for the purposes of this invention.) The voicemail is converted to email, with the voicemail audio transcribed into text or attached to the email as a wave file. The email is sent to the client, along with a click-to-talk icon, so that the client can call the host back. In this alternative embodiment, we expect that the client has probably subscribed to a service that converts incoming voicemail to incoming email and attaches a click-to-talk icon. The host's callback number may be collected from the host's Caller ID, ANI, SIP address, other automatically collected information identifying the host, or by asking the host to specify a callback number by either speaking the number, dialing the number, or typing the number. This alternative embodiment is illustrated in FIG. 8.

FIG. 8 illustrates how a click-to-talk button is attached to incoming voicemail. A host leaves voicemail for a client in block 810. The voicemail is converted to email in block 820. A callback number or equivalent identifier for the host is collected in block 830. Email is sent to the client with a click-to-talk software application attached in block 840. The client receives the email and clicks on the icon in block 850. The client software sets up a communication path between the client and the host in block 860. This communication path may optionally include a video signal.

Note that other variations described above for the embodiment where the host sends an email apply to the alternative embodiment where the host leaves voicemail that is converted to email. One of these variations is the option of connecting the client to a voice assistant first, then connecting the client to a host. Other variations include using speech recognition to control the process with voice input, find-me, and call blast.

It is to be understood that this application discloses a system and method for selecting an icon, connecting to a voice assistant, and setting up a call with between a client and a host. While the invention is particularly illustrated and described with reference to example embodiments, it will be understood by those skilled in the art that various changes in form, details, and applications may be made therein. For example, instead of clicking a single icon, the client may select two items such as a telephone number shown in the computer display and a click-to-talk icon. Although the disclosure here refers to voice calls and connections, it is to be understood that the invention applies also to video calls.

What is claimed is:

1. A method of providing access to voice or data services comprising:
a client selecting an icon;
setting up a voice path between said client and a voice assistant; and
said voice assistant setting up a voice path between said client and a host.

2. The method of claim 1, wherein said voice assistant collects a voice sample from said client.

3. The method of claim 2, wherein said voice sample identifies one of the following: the host or the client.

4. The method of claim 2, wherein said voice assistant plays at least one touch-tone signal in response to said voice sample.

5. The method of claim 2, wherein said voice sample is used to set up said voice path between said client and a host.

6. The method of claim 1, wherein said setting up a voice path between said client and said host includes placing a call to a first telephone number.

7. The method of claim 6, wherein said first telephone number is associated with said icon.

8. The method of claim 7, wherein said first telephone number is associated with said icon by a character string sent to a computer used by said client.

9. The method of claim 8, wherein said character string contains at least one of the following: a telephone number or an identifier associated with said host.

10. The method of claim 9, wherein said identifier associated with said host is associated with at least one telephone number in a database.

11. The method of claim 9, wherein said identifier associated with said host is an email address.

12. The method of claim 6, further comprising a step wherein a determination is made as to whether the host has been reached.

13. The method of claim 12, further comprising a step wherein, if it is determined that said host has been reached, a voice path is set up between said client and said host.

14. The method of claim 12, further comprising a step wherein, if it is determined that said host has not been reached, a second telephone number is tried.

15. The method of claim 12, further comprising a step wherein, if it is determined that all host telephone numbers have been tried unsuccessfully, the client is able to attempt an alternate action.

16. The method of claim 15, wherein said alternate action constitutes one or more of the following: leaving voicemail or trying to call an alternate destination.

17. The method of claim 6, wherein said first telephone number and a second telephone number are called simultaneously.

18. The method of claim 17, wherein if it is determined that said host has been reached, a voice path is set up between said client and said host.

19. The method of claim 1, wherein said voice path between said client and said voice assistant travels over one or more of the following: a telephone line, a VoIP line, a peer-to-peer connection, or a wireless network.

20. The method of claim 6, wherein said voice path between said client and said host travels over one or more of the following: a telephone line, a VoIP line, a peer-to-peer connection, or a wireless network.

21. The method of claim 1, wherein said icon is defined at least partly by one or more parameters.

22. The method of claim 21, wherein at least one of said parameters is used to set up said voice path between said client and said voice assistant and/or said host.

23. The method of claim 21, wherein at least one of said parameters is transmitted to said voice assistant.

24. The method of claim 23, wherein said transmitted parameter is used to set up said voice path between said client and a host.

25. The method of claim 1, further comprising the step of said client leaving a message upon said host being unreachable.

26. The method of claim 25, further comprising the step of said client collecting a callback number before or during said setting up a voice path.

27. The method of claim 25, further comprising the step of said client collecting a callback number upon said host being unreachable.

28. The method of claim 25, further comprising the step of said host calling back said client by setting up a voice path to client software associated with said icon.

29. A method of providing access to voice or data services comprising:
a client selecting an icon;
playing a prompt to a host;
receiving a response from said host;
upon a first response from said host, setting up a voice path between said client and said host; and
upon a second response from said host, taking action other than setting up a voice path between said client and said host.

30. The method of claim 29 wherein said action other than setting up a voice path between said client and said host includes playing a prompt to said client.

31. The method of claim 29 wherein said action other than setting up a voice path between said client and said host includes taking a voice message.

32. A method of providing access to voice or data services comprising
a client selecting an icon;
playing an advertisement to said client; and
setting up a voice path between said client and said host.

33. The method of claim 32 further comprising the step of selling a product or service to said client in response to action taken by said client in response to said advertisement.

34. The method of claim 33 wherein said selling a product or service includes collecting billing information from said client.

35. A method of voice communication comprising:
converting a voicemail message left by a host to an email message;
attaching a click-to-talk application to said email message;
a client selecting said click-to-talk application; and
setting up a voice path between said client and said host.

36. The method of claim 35, further comprising the step of connecting said client to a voice assistant.

37. The method of claim 35, wherein setting up a voice path between said client and said host includes attempting to reach said host at least two telephone numbers.

38. The method of claim 35, further comprising the step of collecting a voice sample and identifying at least part of said voice sample with a speech recognizer.
